(19) United States
(12) Patent Application Publication
(10) Pub. No.: US 2007/0129937 A1
(43) Pub. Date: Jun. 7, 2007

(54) Apparatus and method for deterministically constructing a text question for application to a data source

(75) Inventors: Nicholas Guy Kellet, Kelowna (CA); Steve Kopp, Paris (FR); Luke William Evans, West Vancouver (CA); Saurabh Abhyankar, Levallois-Perret (FR); Jean-Paul Jolinon, Ruislip (GB)

Correspondence Address: COOLEY GODWARD KRONISH LLP, 3000 EL CAMINO REAL, 5 PALO ALTO SQUARE, PALO ALTO, CA, 94306, US

(73) Assignee: Business Objects, S.A., Levallois-Perret (FR)

(21) Appl. No.: 11/488,441

(22) Filed: Jul. 17, 2006

Related U.S. Application Data
(63) Continuation-in-part of application No. 11/102,488, filed on Apr. 7, 2005.

(30) Foreign Application Priority Data
Apr. 4, 2006 (US) PCT/US06/12286

(51) Int. Cl. G06F 17/27

(52) U.S. Cl. 704/9

(57) ABSTRACT

A computer readable medium stores executable instructions to deterministically construct a text question for application to a data source. The executable instructions include executable instructions supply a user with an initial text question. The user is allowed to alter a sentence component of the initial text question to form an altered sentence component. It is identified when the altered sentence component in combination with remaining sentence components creates a grammatically incorrect question. A grammatically correct text question including the altered sentence component is supplied in response to the executable instructions to identify. A data source query is constructed from the grammatically correct text question. The data source query is applied to a data source to produce data results. The data results are presented to the user.

### CROSS REFERENCE TO RELATED APPLICATIONS

This application is a continuation-in-part of previously filed, commonly owned U.S. patent application Ser. No. 11/102,488, filed Apr. 7, 2005 and titled Apparatus and Method for Deterministically Constructing a Text Question for Application to a Data Source, the contents of which are incorporated by reference herein. This application is also related to the following previously filed, commonly owned patent applications, each of which is incorporated by reference herein:

Apparatus and Method for Deterministically Constructing a Text Question for Application to a Data Source, Ser. No. 11/267,041, filed Apr. 11, 2005.

Apparatus and Method for Data Modeling Business Logic, Ser. No. 11/102,613, filed Apr. 7, 2005;

Apparatus and Method for Utilizing Sentence Component Metadata to Create Database Queries, Ser. No. 11/102,477, filed Apr. 7, 2005; and

Apparatus and Method for Constructing Complex Database Query Statements Based on Business Analysis Comparators, Ser. No. 11/102,562, filed Apr. 7, 2005.

### BRIEF DESCRIPTION OF THE INVENTION

This invention relates generally to accessing digital data. More particularly, this invention relates to a technique for deterministically constructing a text question that can be converted to a data source query for application to a digital data source.

### BACKGROUND OF THE INVENTION

Business intelligence generally refers to software tools used to improve business enterprise decision-making. These tools are commonly applied to financial, human resource, marketing, sales, customer and supplier analyses. More specifically, these tools can include: reporting and analysis tools to present information; content delivery infrastructure systems for delivery and management of reports and analytics; data warehousing systems for cleansing and consolidating information from disparate sources; and, data management systems, such as relational databases or On Line Analytic Processing (OLAP) systems used to collect, store, and manage raw data.

Given the disparate roles performed by business intelligence tools and the vast amount of data that they are applied against, there are ongoing efforts to simplify their use. In their most successful manifestations, non-technically trained personnel can use business intelligence tools. To achieve this, it is important to insulate non-technically trained personnel from the complexities of the underlying data sources. Users of business intelligence tools generally have knowledge of the information that they want; the challenge is translating this knowledge into appropriate queries that can be applied to an underlying data source.

Ideally, a business intelligence tool provides an interface that allows a user to think on his or her own terms, but still allows for data source queries that can be efficiently applied against a data source. Since business intelligence users commonly think in terms of text-based queries, it would be desirable to provide such users with text-based queries that can be used directly and/or that can be used with user-selected modifications to the original text-based queries. Ideally, such a system would only permit the construction of text-based queries that can be converted into data source queries.

### SUMMARY OF INVENTION

The invention includes a computer readable medium that stores executable instructions to deterministically construct a text question for application to a data source. The executable instructions include executable instructions supply a user with an initial text question. The user is allowed to alter a sentence component of the initial text question to form an altered sentence component. It is identified when the altered sentence component in combination with remaining sentence components creates a grammatically incorrect question. A grammatically correct text question including the altered sentence component is supplied in response to the executable instructions to identify. A data source query is constructed from the grammatically correct text question. The data source query is applied to a data source to produce data results. The data results are presented to the user.

### BRIEF DESCRIPTION OF THE FIGURES

The invention is more fully appreciated in connection with the following detailed description taken in conjunction with the accompanying drawings, in which:

FIG. 1 illustrates a computer constructed in accordance with an embodiment of the invention.

FIG. 2 illustrates processing operations associated with an embodiment of the invention.

FIG. 3 illustrates a simple question panel configured in accordance with an embodiment of the invention.

FIG. 4 illustrates the alteration of sentence components of the question panel of FIG. 3 in accordance with an embodiment of the invention.

FIG. 5 illustrates data results produced by the exemplary question panels of FIGS. 3 and 4.

FIG. 6 illustrates another question panel configured in accordance with an embodiment of the invention.

FIG. 7 illustrates the alteration of sentence components of the question panel of FIG. 6 in accordance with an embodiment of the invention.

FIG. 8 illustrates the selection of data result formatting options in accordance with an embodiment of the invention.

FIG. 9 illustrates data results produced by the exemplary question panels of FIGS. 6-8.

FIG. 10 illustrates an expression editor to produce personal filter criteria in accordance with an embodiment of the invention.

FIG. 11 illustrates various question templates that may be used in accordance with an embodiment of the invention.

FIG. 12 illustrates a computer constructed in accordance with a further embodiment of the present invention

FIG. 13 illustrates a series of processing operations associated with a further embodiment of the invention.

FIG. 13A illustrates a series of user workflow operations associated with an embodiment of the invention.

FIG. 14 illustrates a simplified question panel configured in accordance with an embodiment of the invention.

FIG. 15 illustrates the alteration of selectable sentence components of the question panel of FIG. 14 in accordance with an embodiment of the invention.

FIG. 16 illustrates data results produced by the exemplary question panels of FIGS. 14 and 15.

FIG. 17 illustrates another simplified question panel configured in accordance with an embodiment of the invention.

FIG. 18 illustrates the alteration of selectable sentence components of the question panel of FIG. 17 in accordance with an embodiment of the invention.

FIG. 19 illustrates data results produced by the exemplary question panels of FIGS. 17-19.

Like reference numerals refer to corresponding parts throughout the several views of the drawings.

### DETAILED DESCRIPTION OF THE INVENTION

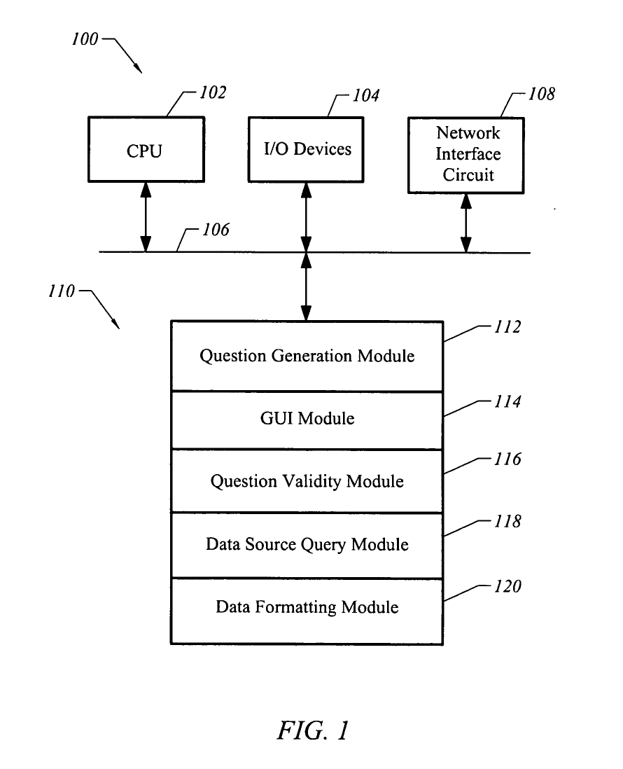

FIG. 1 illustrates a computer 100 configured in accordance with an embodiment of the invention. The computer 100 includes standard components, including a central processing unit 102 and input/output devices 104, which are linked by a bus 106. The input/output devices 104 may include a keyboard, mouse, touch screen, monitor, printer, and the like. A network interface circuit 108 is also connected to the bus 106. The network interface circuit 108 provides connectivity to a network (not shown), thereby allowing the computer 100 to operate in a networked environment.

A memory 110 is also connected to the bus 106. The memory 110 stores executable instructions to implement operations of the invention. In one embodiment, the executable instructions include a question generation module 112. The question generation module 112 includes executable instructions to provide an initial question to a user. The initial question may be supplied to the user through a default selection or through a previous specified question selection. Question selection may be predicated upon a template of questions. For example, the template of questions may be divided by enterprise function, such as marketing, finance, and the like. The question may also be based upon previous customized questions, either created by the user or by another user. Alternately, the question may be selected from a list of frequently asked questions or a list of recently asked questions. In one embodiment of the invention, predicted questions may be supplied based upon the previous behavior of a user or group of users. As discussed below, questions may be based upon personal filter criteria established by a user.

Memory 110 also stores a Graphical User Interface (GUI) module 114. The GUI module 114 may rely upon standard techniques to produce graphical components, such as pull-down menus, radio buttons, and the like, examples of which are discussed below.

Memory 110 also stores a question validity module 116. The question validity module includes executable instructions to ensure that only valid questions are presented to a user or constructed by a user. In one embodiment, the question validity module includes executable instructions to ensure that all displayed components form a valid question. A valid question is defined as a text question that can be translated to a legitimate data source query. In another embodiment, the question validity module includes executable instructions to ensure that all selectable components (i.e., those displayed and those available for selection) form a valid question, regardless of the component combination. This may require the deletion of selectable components based upon previously selected components. Alternately, this may allow the addition of selectable components based upon previously selected components. In one embodiment, the question validity module 116 includes executable instructions to predict a complete text-based question based upon the selection of one or more selectable components. For example, the selection of two selectable components may result in the question validity module 116 generating a new text-based question with new components. The new components may be automatically selected based upon the previous behavior of the user or based upon the previous behavior of another group of users.

The question validity module 116 ensures that in the dynamic operation of constructing a text-based query, only legitimate queries are generated. Thus, the module deterministically constructs a text question that will be successfully applied to a data source. This stands in sharp contrast to prior art techniques in which a text-based question is constructed, but might fail upon execution because of improper form and/or content. Such a run-time failure is advantageously prevented through use of the question validity module of the invention.

A data source query module 118 is also stored in memory 110. The data source query module 118 includes executable instructions to translate the final text-based query into a data source query, e.g., a Structured Query Language (SQL) query. As previously indicated, the question validity module 116 ensures that only valid text questions are generated, therefore, the data source query module 118 is always in a position to translate a text-based query into a data source query. The data source query module 118 also includes executable instructions to apply the generated data source query to an underlying data source, which may form a portion of computer 100 or may be accessed as a separate networked machine through the network interface circuit 108.

The question validity module 116 and the data source query module 118 may be implemented in accordance with any number of techniques, including those described in the following concurrently filed, commonly owned patent applications, each of which is incorporated by reference herein: Apparatus and Method for Data Modeling Business Logic, Ser. No. 11/102,613, filed Apr. 7, 2005; Apparatus and Method for Utilizing Sentence Component Metadata to Create Database Queries, Ser. No. 11/102,477, filed Apr. 7, 2005; and Apparatus and Method for Constructing Complex Database Query Statements Based on Business Analysis Comparators, Ser. No. 11/102,562, filed Apr. 7, 2005.

Memory 110 may also store a data formatting module 120. The data formatting module includes executable instructions to produce user-selectable data output formatting options. The data output formatting options may directly correspond to displayed sentence components of the text-based question. In addition, the data output formatting options may include components that are not directly specified by the displayed sentence components, as will be illustrated below.

The executable modules stored in memory 110 are exemplary. It should be appreciated that the functions of the modules maybe combined. In addition, the functions of the modules need not be performed on a single machine. Instead, the functions may be distributed across a network, if desired. Indeed, the invention is commonly implemented in a client-server environment with various components being implemented at the client-side and/or the server-side. It is the functions of the invention that are significant, not where they are performed or the specific manner in which they are performed.

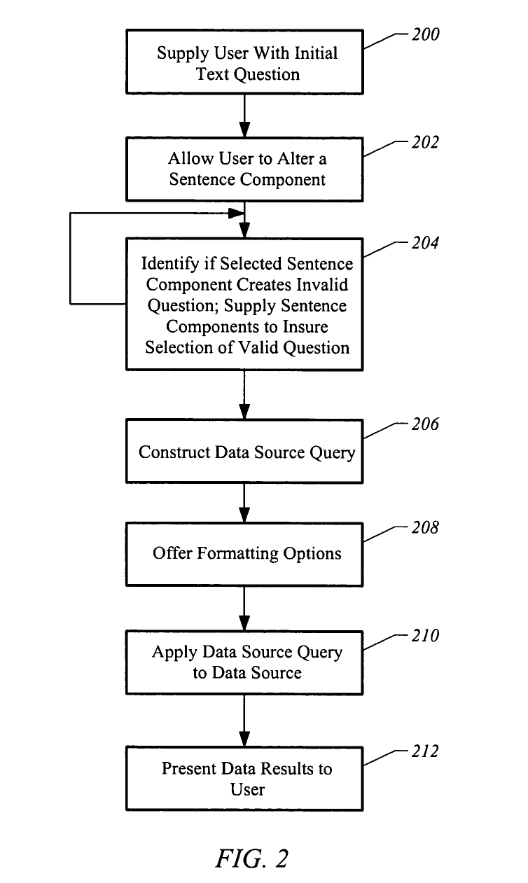

FIG. 2 illustrates processing operations that may be implemented by the computer 100. The first processing operation of FIG. 2 is to supply a user with an initial text question 200. The question generation module 112 may be used to implement this operation. As previously indicated, the initial text question may be generated from a template, previously customized questions, frequently asked questions, recently asked questions, and/or predicted questions.

The next operation of FIG. 2 is to allow a user to alter a sentence component 202. As will be shown through various examples below, alteration of a sentence component may be implemented through the use of pull-down menus. The GUI module 114 may be used to implement this operation.

The next processing operation of FIG. 2 is to identify if a selected sentence component creates an invalid question. If so, sentence components are supplied to ensure the selection of a valid question 204. The question validity module 116 is used to implement this operation. As previously indicated, the question validity module 116 can be implemented to ensure that all displayed components form a valid question. The question validity module 116 may also be implemented to ensure that all selectable components potentially form a valid question, regardless of the combination of components. The operation of block 204 may be repeated until the user indicates that a final text-based question is prepared.

The next processing operation of FIG. 2 is to construct a data source query 206. This operation may be implemented using the data source query module 118. As previously indicated, the data source query module translates the text-based question into an equivalent data source (e.g., SQL) query.

An optional additional step is to offer formatting options 208. As will be illustrated below, the formatting options provide various user-selectable data presentation options to a user. The data formatting module 120 may be used to implement this operation.

The data source query (and the data formatting options, if selected) is then applied to a data source 210. The query module 118 may be used to implement this operation.

Finally, data results are presented to the user 212. The presentation operation may be implemented using the GUI module 114.

The apparatus and method of the invention has been fully described. Attention now turns to various specific examples to more fully illuminate the nature and benefits of the invention.

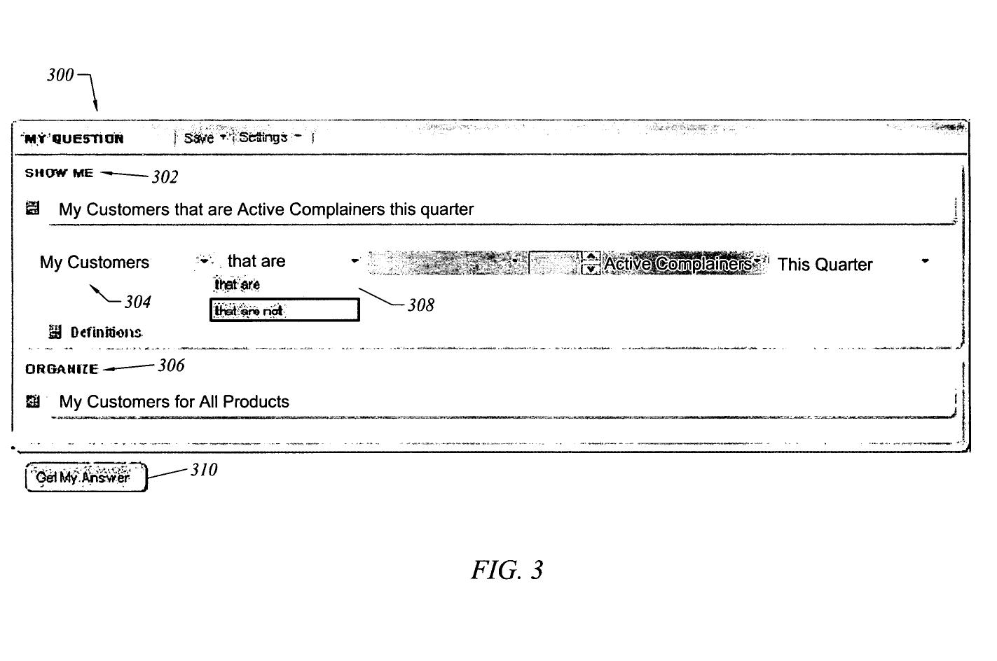

FIG. 3 illustrates a graphical user interface (GUI) 300 used to implement an embodiment of the invention. The GUI 300 includes a question panel 302, which displays a text-based question with selectable components 304. The GUI 300 also includes a formatting panel 306, which provides options for formatting data produced in response to the text-based query generated in the question panel 302.

FIG. 3 illustrates that a pull-down menu 308 is used to select components of the text-based question 304. By selecting a new component (e.g., “that are not”) in the pull-down menu 308, a new text-based question is formed. The question validity module 116 is then invoked to confirm that the selected components of the text-based question can be translated into a valid data source query. Alternately, the question validity module 116 may be implemented so that a valid data source query was ensured by only supplying selectable data components that would produce a valid data source query.

In the example of FIG. 3, the text-based query includes a subject (i.e., “Customers”), a verb (i.e., “are”), a predicate noun (i.e., “complainers”), and a time period (i.e., “this quarter”). These are common components in the text-based queries utilized in accordance with embodiments of the invention. However, alternate and additional sentence components may also be used in accordance with embodiments of the invention.

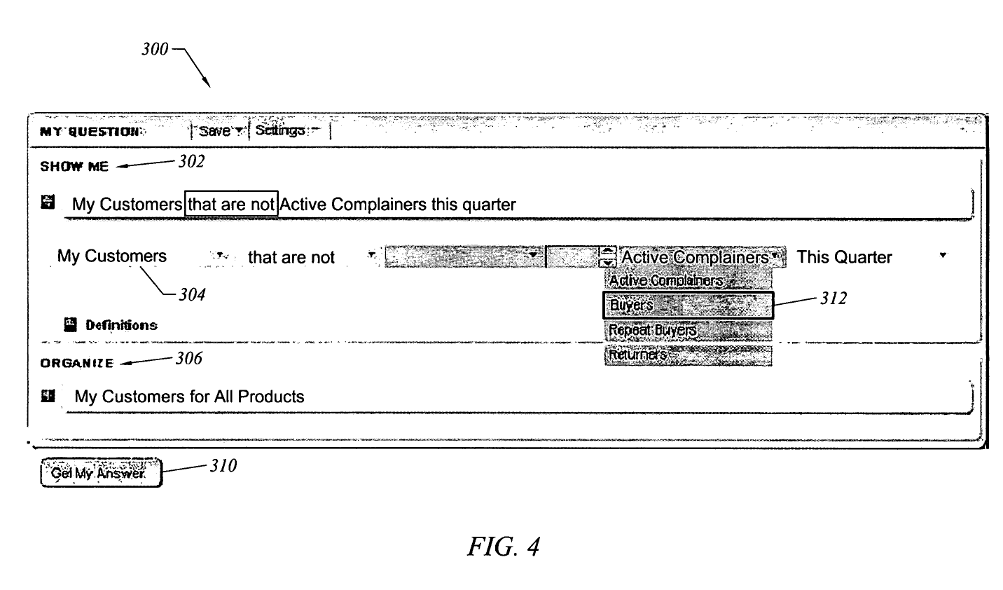

FIG. 4 generally corresponds to FIG. 3, but in FIG. 4 a pull-down menu 312 is activated for the selection of different selectable components (i.e., different predicate nouns, such as “buyers”, “returners”, etc.). The other sentence components also have associated pull-down menus, although not explicitly shown in this example.

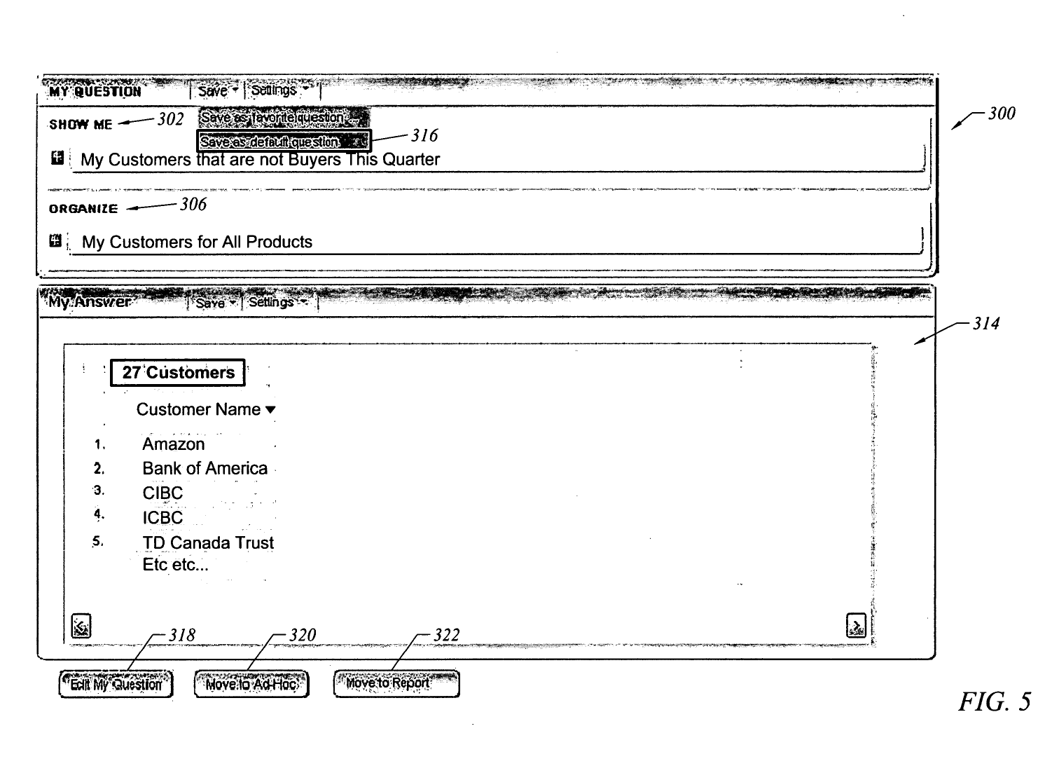

FIGS. 3 and 4 can be used to illustrate several of the processing operations associated with FIG. 2. For example, FIG. 3 illustrates that a user is supplied with an initial text question (block 200 of FIG. 2). FIGS. 3 and 4 illustrate that a user is allowed to alter one or more sentence components (block 202 of FIG. 2). When the “Get My Answer” button 310 is selected, a data source query is constructed (block 206 of FIG. 2) and is subsequently applied to a data source (block 210 of FIG. 2). FIG. 5 illustrates the result of this operation.

FIG. 5 illustrates the question panel 302 with the text-based question that was constructed, as shown in FIGS. 3 and 4. The figure also illustrates a results panel 314, which shows the results of the text-based query. FIG. 5 also illustrates that the question may be saved using pull-down menu 316. The pull-down menu 316 provides options, such as “Save as favorite question” and “Save as default question”. The question generation module 112 can then process this information. As previously discussed, the question generation module 112 is used to initially present a question to a user. The question may be presented based upon any number of criteria. In FIG. 5, a user's own previously customized question is saved as a default question for subsequent interactive sessions. The question generation module 112 may also present a question based upon a template, frequently asked questions, recently asked questions, predicted questions and the like.

FIG. 5 also illustrates an “edit my question button”. If selected, the user would be once again presented with a GUI, such as shown in FIGS. 3 and 4. A “Move to Ad-Hoc” button 320 and a “Move to Report” button 322 are also shown in FIG. 5. The “Move to Ad-Hoc” button 320 is used to move a question to an ad-hoc question repository. The “Move to Report” button is used to move the results information to a report that can be distributed.

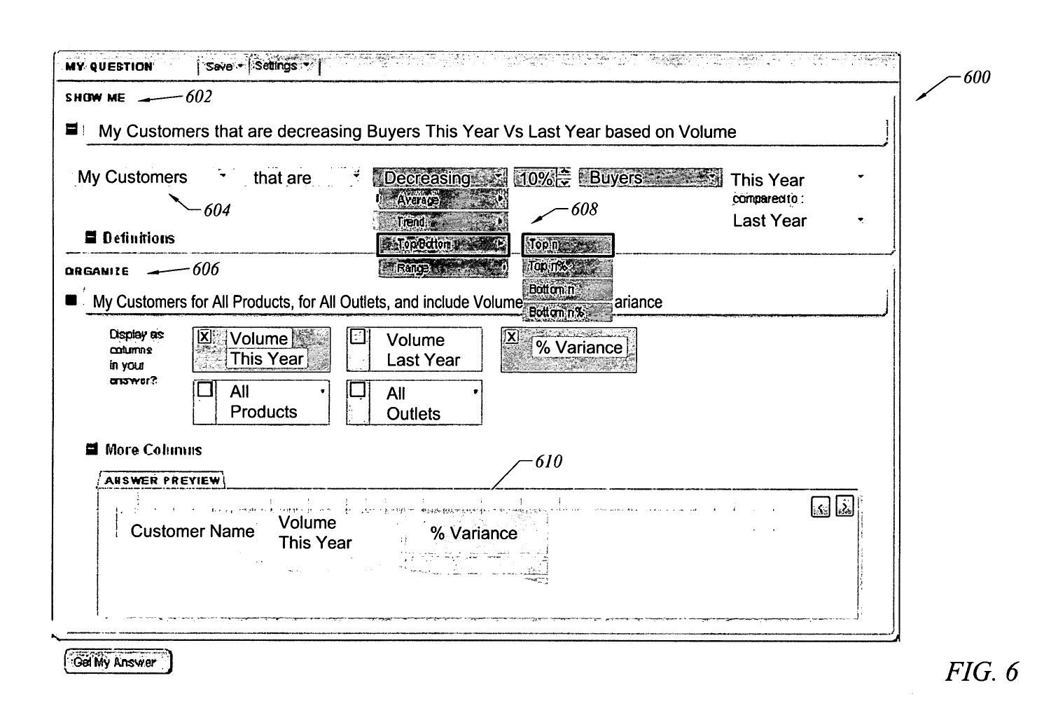

FIG. 6 illustrates another GUI 600 that may be used in accordance with an embodiment of the invention. The GUI 600 includes a question panel 602 with a text-based question 604. In this example, cascaded pull-down menus 608 are supplied for selectable components of the sentence 604. The formatting panel 606 in this example is more sophisticated than in the previous example. Observe that the formatting panel 606 has formatting options that correspond to selectable components of the sentence 604 (e.g., “Volume This Year”). The formatting panel 606 also has formatting options that do not appear in the selectable components of the sentence 604 (e.g., “All Products”). An Answer Preview field 610 provides a preview based upon the selections made in the formatting panel 606.

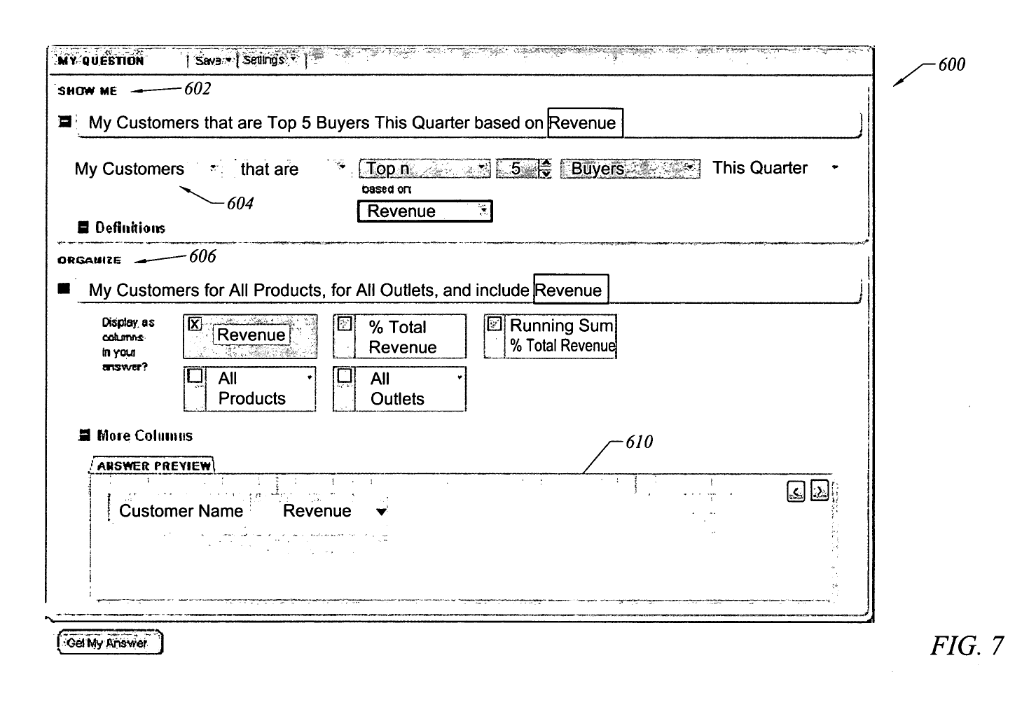

FIG. 7 generally corresponds to FIG. 6, but shows a different formed question 604, based upon the selections made in FIG. 6. The figure also illustrates a different Answer Preview 610 based upon the selections made in the formatting panel 606. The question generation module 112 may be used to create a new question, such as shown in FIG. 7, based upon previous selections, such as those made in FIG. 6. For example, the question generation module 112 may include executable instructions to identify instances when certain intermediate selections result in a certain final query. Subsequently, when the same intermediate selections are chosen, the question generation module 112 may automatically supply the certain final query. Any such predictive question may be altered through the selectable components, if necessary, to meet the user's current query objectives.

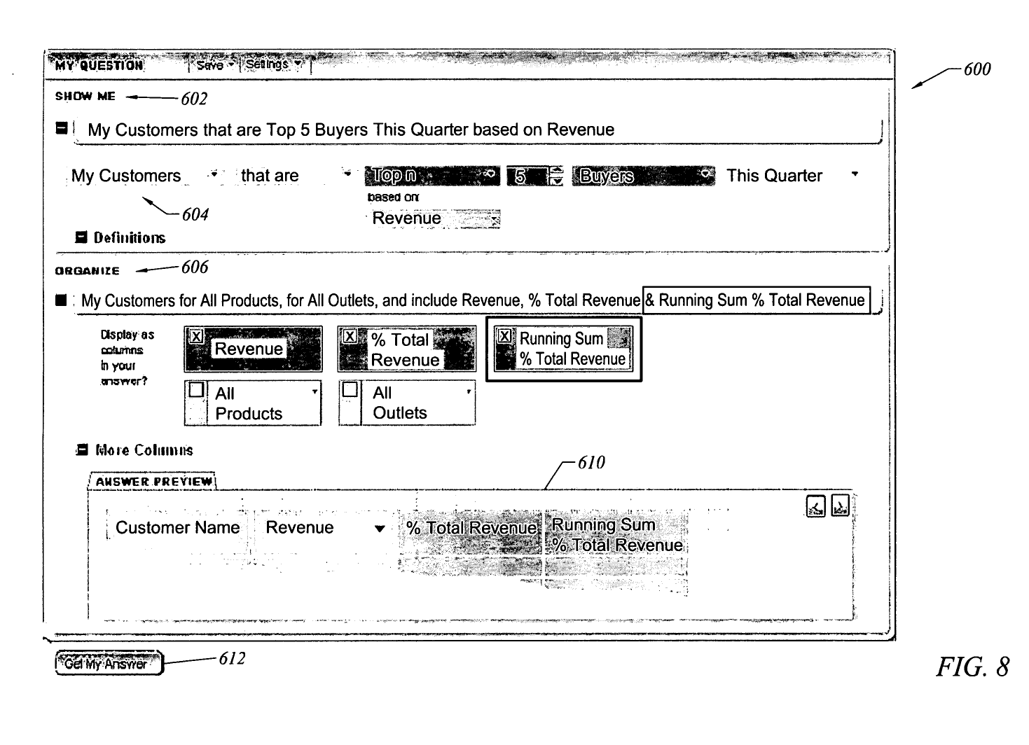

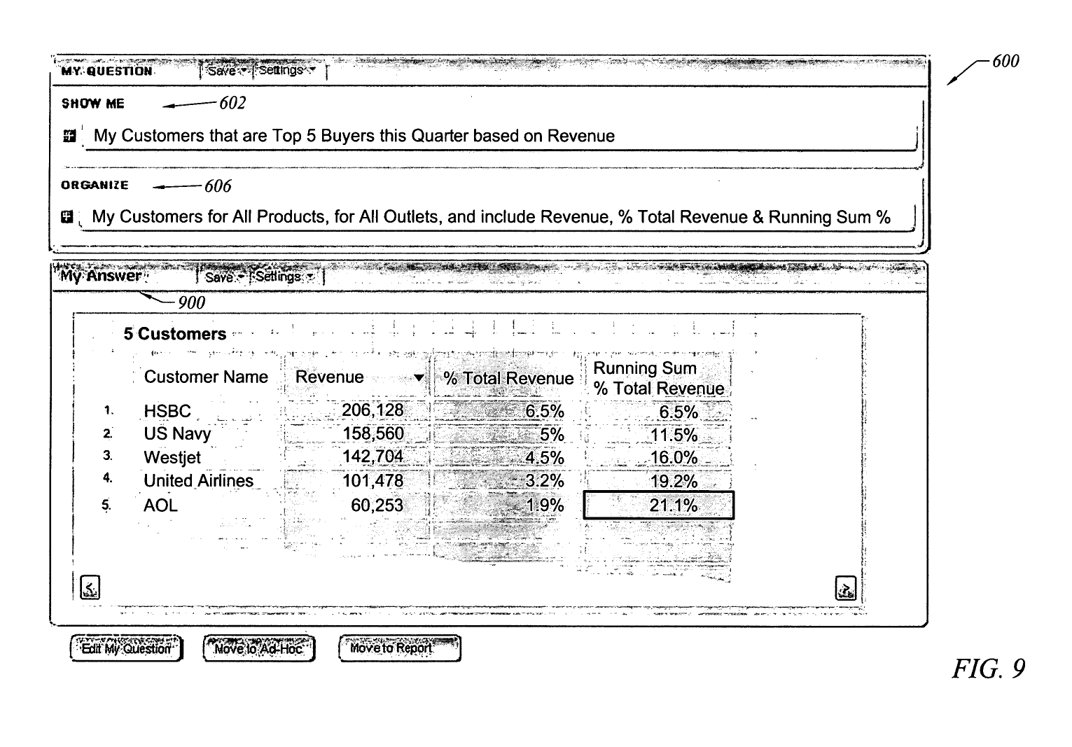

FIG. 8 generally corresponds to FIG. 7, but shows different selections made in the formatting panel 606. Thus, the Answer Preview field 610 has a different appearance. FIG. 8 also illustrates that the “Get My Answer” button 612 is highlighted for selection. This operation results in the production of an answer, as shown in FIG. 9. FIG. 9 illustrates the final question in question panel 602, the final organizational schema as shown in formatting panel 606, and the answer, as shown in answer panel 900.

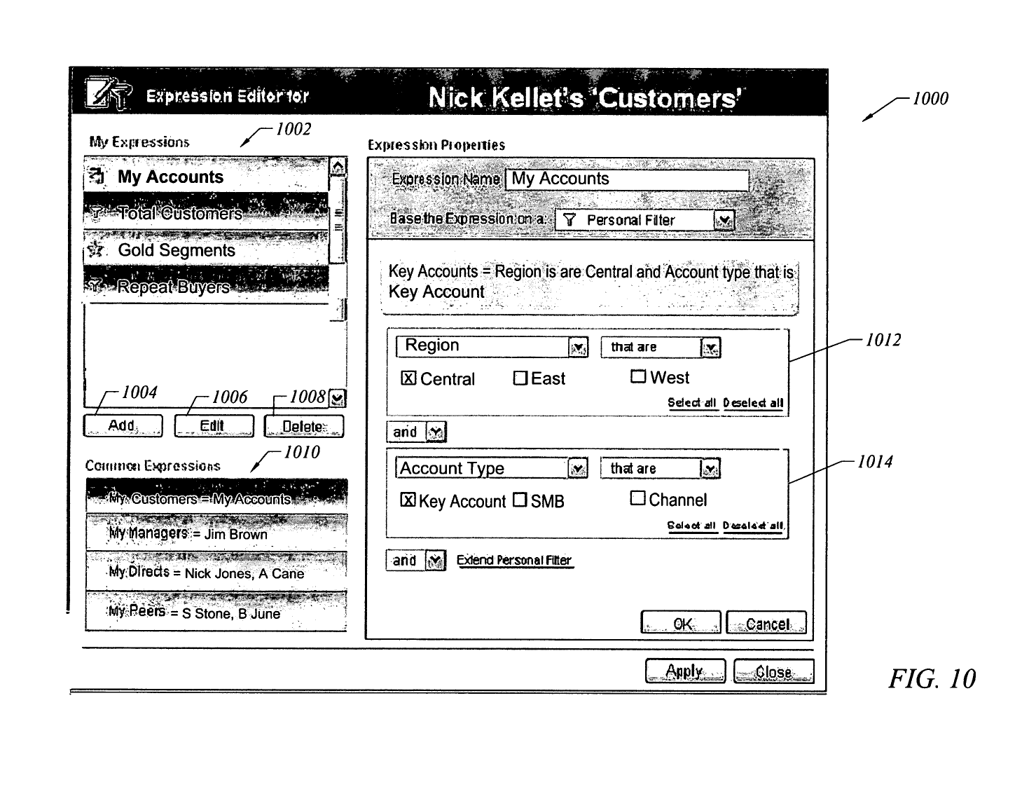

FIG. 10 illustrates an expression editor 1000 utilized in accordance with an embodiment of the invention. In this example, the expression editor is used to customize questions associated with a user's customers. A “My Expressions” block 1002 allows for the characterization of different customers. In this example, the customers are characterized as “My Accounts”, “Test Customers”, “Gold Segments”, and “Repeat Buyers”. Add, Edit, and Delete buttons, 1004, 1006, and 1008, respectively, are used to alter the contents of block 1002.

A “Common Expressions” block 1010 is also supplied. This block allows for alternate characterizations of customers. So, for example, the customers may be classified as customers of “My Managers”, “My Direct (Reports)”, and “My Peers”. The invocation of common expressions allows a user to access questions used by others in an organization.

FIG. 10 also illustrates that expression properties are configurable. As shown in FIG. 10 in block 1012, a central region may be designated as a region of interest. Characterization of an account may also be established through block 1014.

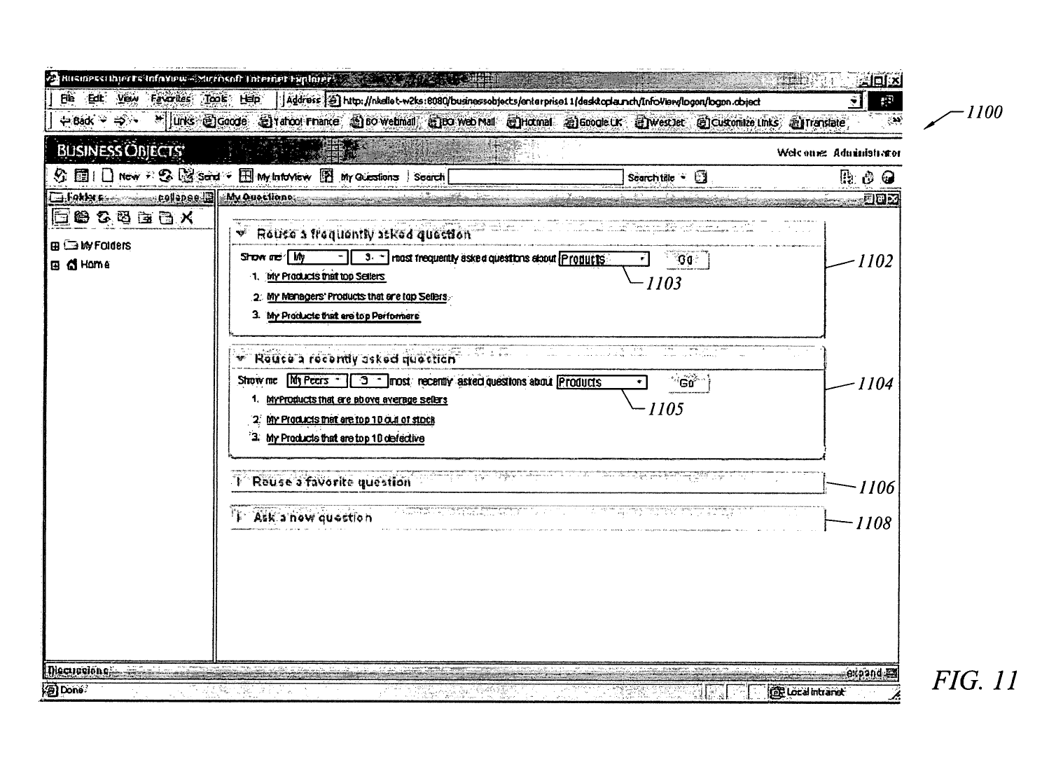

FIG. 11 illustrates a browser-based GUI 1100 that may be used in accordance with another embodiment of the invention. The GUI 110 includes a block 1102 specifying frequently asked questions. The questions shown in FIG. 11 are those of the user, but questions of another user may also be displayed. Observe the pull-down menus (e.g., 1103) that allow for alteration of the type of frequently asked question.

The GUI 1000 may be formed using the GUI module 114 in combination with the question generation module 112. In particular, the GUI module 114 may be used to control the visual appearance of the display, while the question generation module 112 may be used to supply and store expressions and expression properties.

FIG. 11 also shows a block 1104 specifying recently asked questions. In this example, the most recently asked questions relate to “My Peers 3 most recently asked questions about Products”. Thus, frequently asked questions of another are requested. Recall that “My Peers” was specified in block 1010 of FIG. 10. Pull-down menus (e.g., 1105) allow different types of recently asked questions to be presented.

FIG. 11 also illustrates a block 1106 for reusing a favorite question and a block 1108 to form a new question. The GUI 1100 may be formed using the GUI module 114 in combination with the question generation module 112. In particular, the GUI module 114 may be used to control the visual appearance of the display, while the question generation module 112 may be used to supply the various questions.

The invention provides for structured text-based questions, which are familiar to users. Note that the operation of the invention commences with an existing question. Thus, the user is not provided with a blank screen, which must be filled. Instead, the user has a starting point to direct his or her actions. The invention provides text queries that are limited (i.e., limited to the selectable components displayed) and mutually constraining (i.e., the selectable components are constrained to those components that will result in a valid query that can be applied to the data source). The question validity module 116 ensures that only valid queries can be generated based upon the selectable components supplied to the user. Thus, based upon a set of currently selected components, the remaining selectable components maybe altered to ensure that a valid query could be generated. The matrix of selectable components for any given text-query may be determined beforehand. Therefore, the invention can operate in a dynamic manner without significant computational expense.

The invention provides a visual and semantic metaphor to build questions to define sets of data. The visual and semantic metaphor allows non-technically trained users to obtain the data that they need in an intuitive manner. The question validity module 116 ensures correct and unambiguous semantics at all times. Thus, run-time errors do not occur.

Many refinements of the disclosed technology are possible. For example, when a user alters a sentence component, the visible appearance of the altered sentence component may be modified (e.g., through highlighting, bolding, italics, different font, and the like). This allows the user to track and understand the impact of altering sentence components.

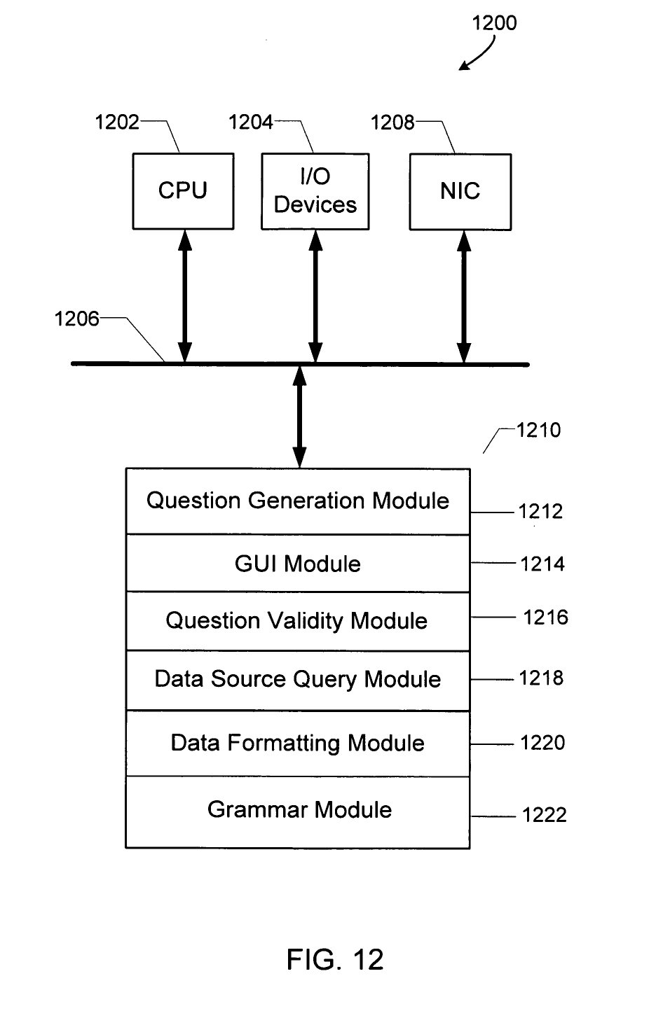

FIG. 12 illustrates a computer 1200 configured in accordance with a further embodiment of the invention. Components 1202-1220 of FIG. 12 respectively correspond to components 102-120 of FIG. 1. However, computer 1200 of FIG. 12 also stores a grammar module 1222. The grammar module 1222 includes executable instructions to ensure that only grammatically correct text questions are supplied to a user, or are constructed by a user. A grammatically correct question is defined as a text question that is structured in such a way as to be as grammatically and syntactically accurate in the language in which it is presented, while still remaining a valid question which can be translated to a legitimate data source query. Grammatical and syntactic accuracy may include factors such as correct subject verb agreement, correct singular and pluralizations, correct masculine and/or feminine forms of words in languages including such elements. In one embodiment, grammatically correct text questions are additionally constructed in such a way as to optimize readability and simplicity of expression. In one embodiment, the grammar module 1222 may reference and apply one or more grammar rules in order to evaluate and ensure the grammatical and syntactic accuracy of text questions. Grammar rules may be stored in the grammar module 1222, or may optionally be stored and referenced from another data source connected to computer 1200. In a particular embodiment, the grammar module 1222 includes executable instructions to ensure that all displayed sentence components form a grammatically correct question. In another particular embodiment, the grammar module 1222 includes executable instructions to ensure that all possible values for selectable sentence components (i.e., those displayed and those available for selection) form a grammatically correct question, regardless of selectable sentence component combinations. This may require the deletion, or modification (such as changing the tense, gender, plurality or form for example) of selectable or non-selectable sentence components, or certain possible values for selectable sentence components, or the re-ordering of selectable or non-selectable sentence components based upon previously selected components. Alternately, this may allow or require the addition of selectable or non-selectable sentence components, or certain possible values for selectable sentence components based upon previously selected components.

In one embodiment of the present invention where the grammar module 1222 references and applies one or more grammar rules, the grammar rules may be tailored to reflect preferred grammar and syntax conventions used by the intended users of the present invention. In particular, the grammar rules may reflect one or more certain grammatical or syntactic conventions used in the industry where the intended users will apply the invention, and in the language and/or dialect used by the intended users of the invention. Alternatively, in an embodiment directed to a multilingual user environment, grammar rules may include specific grammar and syntax conventions for each language in which the invention will be applied.

The executable modules stored in memory 1210 are exemplary. It should be appreciated that the functions of the modules maybe combined. In particular, the functions of the question validity module 1216 and grammar module 1222 may be combined. In addition, the functions of the modules need not be performed on a single machine. Instead, the functions may be distributed across a network, if desired. Indeed, the invention is commonly implemented in a client-server environment with various components being implemented at the client-side and/or the server-side. It is the functions of the invention that are significant, not where they are performed or the specific manner in which they are performed.

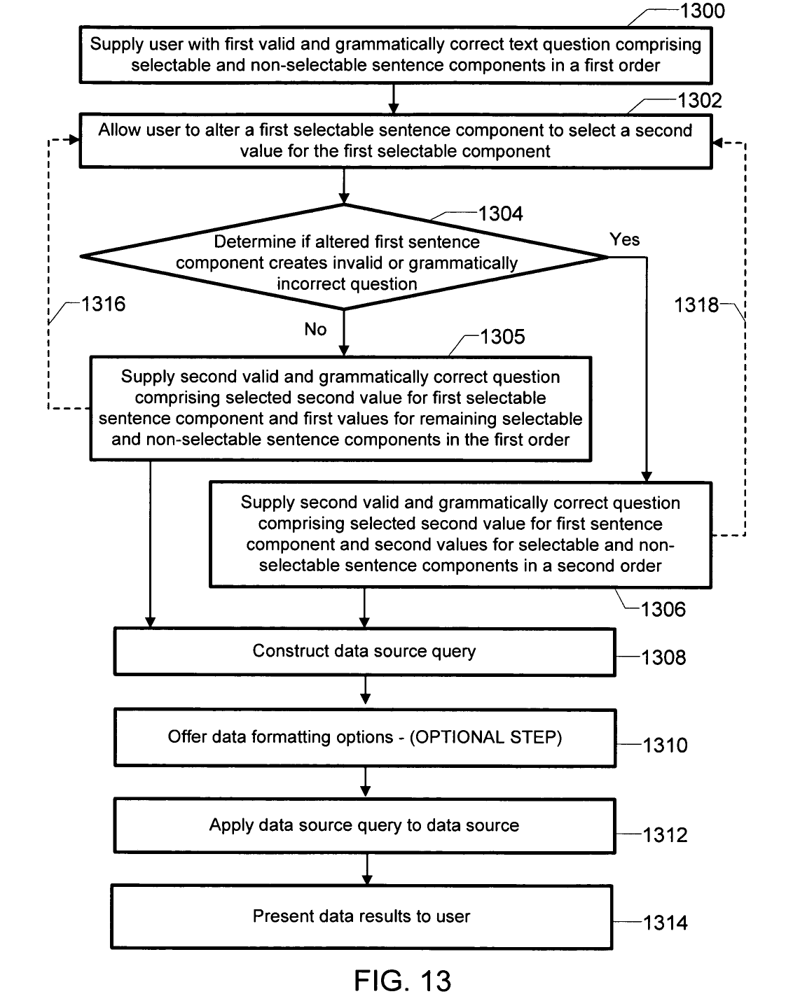

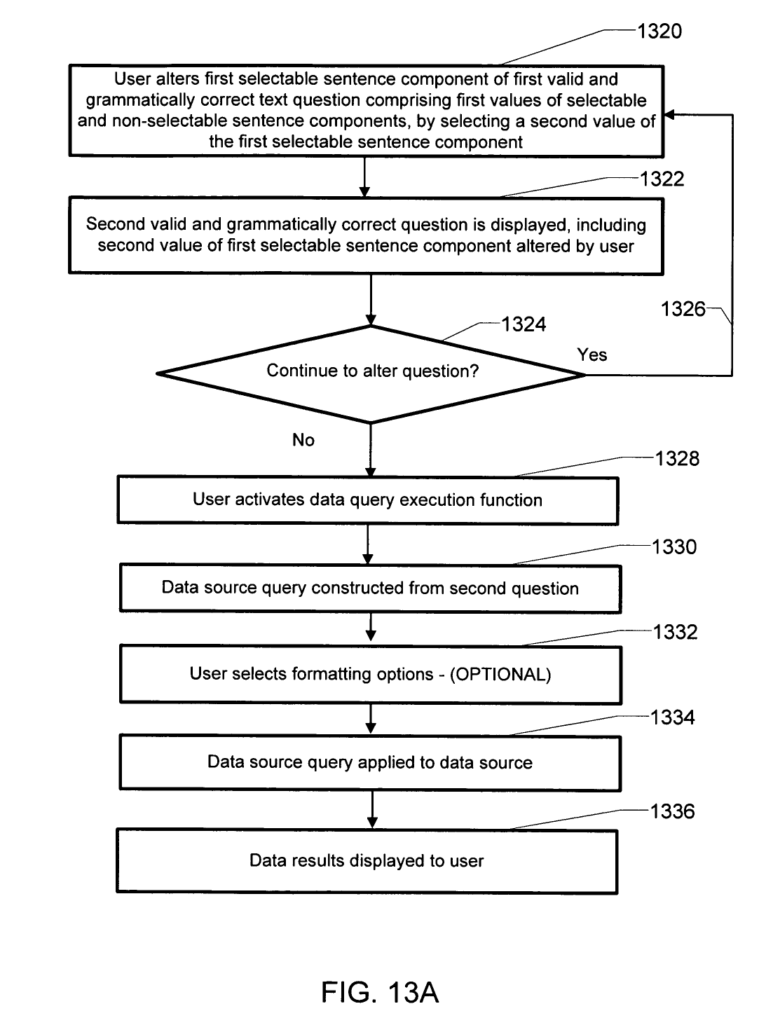

FIG. 13 illustrates a series of processing operations that may be implemented by the computer 1200. The first processing operation of FIG. 13 is to supply 12. a user with a first valid and grammatically correct text question comprising selectable and non-selectable sentence components in a first order 1300. The question generation module 1212 may be used to implement this operation. The first text question may be generated from a template, previously customized questions, frequently asked questions, recently asked questions, and/or predicted questions. In one embodiment, the first text question is adapted to account for the environment of application of the intended user, including factors such as the industry and the language of the intended user, for example.

The next operation of FIG. 13 is to allow a user to alter a first selectable sentence component to select a second value for the first selectable sentence component 1302. As will be shown through various exemplary embodiments below, alteration of a selectable sentence component to select a selectable value may be implemented through the use of pull-down menus, for example. The GUI module 1214 may be used to implement this operation.

The next processing operation of FIG. 13 is to determine if an altered first selectable sentence component creates an invalid or grammatically incorrect question 1304. The question validity module 1216 and the grammar module 1222 may be jointly used to implement this operation.

In an exemplary embodiment where the altered first selectable sentence component is determined to not result in an invalid or grammatically incorrect question, the next processing operation of FIG. 13 is to supply a second valid and grammatically correct question comprising the selected second value for the first selectable sentence component, and first values for the remaining selectable and non-selectable sentence components, in the first order 1305. In an optional embodiment, operations 1302 and 1304 may be repeated following completion of operation 1305, as indicated by optional operation loop 1316.

In an exemplary embodiment where the altered first selectable sentence component is determined to result in an invalid or grammatically incorrect question, the next processing operation of FIG. 13 is to supply a second valid and grammatically correct question comprising the selected second value for the first selectable sentence component, and second values for remaining selectable and non-selectable sentence components, in a second order 1306. The second values of the remaining selectable and non-selectable sentence components supplied in operation 1306 may comprise additions, deletions, or modifications to selectable and/or non-selectable sentence components relative to the first question, as determined by the question validity module 1216 and/or the grammar module 1222 to restore the question to a valid and grammatically correct condition. Further, in such a case, the second order of sentence components in the second valid and grammatically correct question supplied in operation 1306 may be different from the first order of sentence components in the first question supplied in operation 1300, as determined by the question validity module 1216 and/or the grammar module 1222.

The question validity module 1216 and the grammar module 1222 may be jointly implemented to ensure that all displayed selectable and non-selectable sentence component values form a valid and grammatically correct question. In addition, the question validity module 1216 and the grammar module 1222 may also be jointly implemented to ensure that all possible values for selectable sentence components (i.e., those displayed and those available for selection), potentially form a valid and grammatically correct question, regardless of the combination of selectable sentence components. In an optional embodiment, operations 1302 and 1304 may be repeated as indicated by optional operation loop 1318. In an exemplary embodiment of the invention, a validity/grammar flag may be associated with each possible value for selectable sentence components, where the validity/grammar flag indicates whether the selection of a particular selectable sentence component value requires that the resulting altered text question be evaluated by the question validity module 1216 and/or grammar module 1222 to identify if the question is valid and/or grammatically correct, or if the selection of that particular selectable sentence component value cannot result in a question that is invalid or grammatically incorrect. In this exemplary embodiment, the evaluation of the validity/grammar flag may be incorporated into operation 1304.

The next processing operation of FIG. 13 is to construct a data source query 1308. This operation may be implemented using the data source query module 1218. As previously indicated, the data source query module 1218 translates the text-based second question of operation 1305 or 1306 into an equivalent data source query. The equivalent data source query may be expressed in any suitable known format for querying a data source, such as SQL for example.

An optional additional processing operation of FIG. 13 is to offer data formatting options 1310. As will be illustrated below, the data formatting options provide various user-selectable data presentation options to a user, such as the option to include additional data fields in the data results returned by a data source query, for example. The data formatting module 1220 may be used to implement this operation.

The next processing operation of FIG. 13 is to apply the data source query (and the data formatting options, if selected) to a data source 1312. The data source query module 1218 may be used to implement this operation.

The final processing operation of FIG. 13 is to present the data results to the user 1314. This data result presentation operation may be implemented using the GUI module 1214.

FIG. 13A illustrates a series of user workflow operations according to an aspect of the invention. In the first operation of FIG. 13A, a user alters a first selectable sentence component of a first valid and grammatically correct text question comprising first values of selectable and non-selectable sentence components, by selecting a second value of the first selectable sentence component 1320. The second value selected by the user to alter the first selectable sentence component may be selected from a list of possible values for the first selectable sentence component. The list of possible values may be displayed for selection by the GUI module 1214, such as by using a pull-down menu, for example.

In the second operation of FIG. 13A, a second valid and grammatically correct question is displayed, including the second value of the first selectable sentence component altered by the user 1322. The GUI module 1214 may be used to display the second question in operation 1322.

In the next operation of FIG. 13A, the user decides whether to continue to alter the second question 1324. If the user decides to continue to alter the second question that was displayed in operation 1322, the user workflow may proceed to repeat operations 1320 and 1322, as shown by operation loop 1326. Alternatively, if the user decides not to continue to alter the second question that was displayed in operation 1322, the user workflow proceeds to operation 1328, described below.

In the next operation of FIG. 13A, the user activates a data query execution function 1328. The user may activate the data query execution function by selecting a GUI representation, such as by selecting an icon or a button in a GUI window. The GUI module 1214 may be used to implement this operation.

In the next operation of FIG. 13A, a data source query is constructed from the second question 1330. This operation may be implemented using the data source query module 1218. As previously described, the data source query module translates the text-based question into an equivalent data source (e.g., SQL) query.

In an optional operation of FIG. 13A, the user selects data formatting options 1332. The data formatting options may include multiple user selectable options to control the retrieval and display of data results, such as the option to include additional data fields in the data results returned by a data source query, for example. The data formatting module 1220 may be used to implement this operation.

In the next operation of FIG. 13A, the data source query is applied to the data source 1334. The data source query module 1218 may be used to implement this operation, by applying the data source query (and any data formatting options, if selected) to a data source.

In the final operation of FIG. 13A, the data results resulting from the data query are displayed to the user 1336. This data result display operation may be implemented using the GUI module 1214.

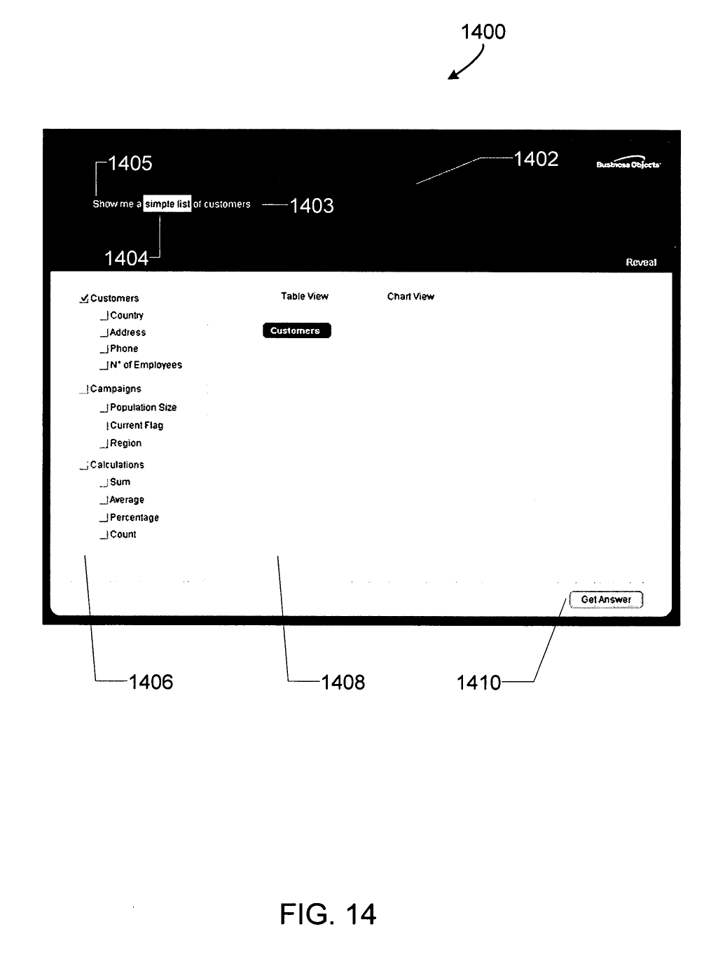

FIG. 14 illustrates a graphical user interface (GUI) 1400 used to implement an embodiment of the present invention. The GUI 1400 comprises a question panel 1402 which displays a text question 1403 comprising sentence components. Sentence components displayed as part of the text question 1403 in question panel 1402 comprise selectable sentence components, such as the type of results selectable sentence component 1404 for which the value “simple list” is selected in the text question 1403 in question panel 1402, and non-selectable sentence components, such as the preface non-selectable sentence component “Show me a” 1405. In one embodiment, selectable sentence components may be displayed in the same manner as non-selectable sentence components in the displayed text question 1403. In another embodiment, selectable and non-selectable sentence components may be displayed differently to enable a user to visually identify between the two. The GUI 1400 also includes a data query execution button 1410, a formatting panel 1406, which provides selectable options for formatting the data retrieved in response to executing a data query based on the text question 1403 displayed in question panel 1402, and results panel 1408 which displays data column headings, and following execution of a data query based on a text question, displays the data retrieved by the data query.

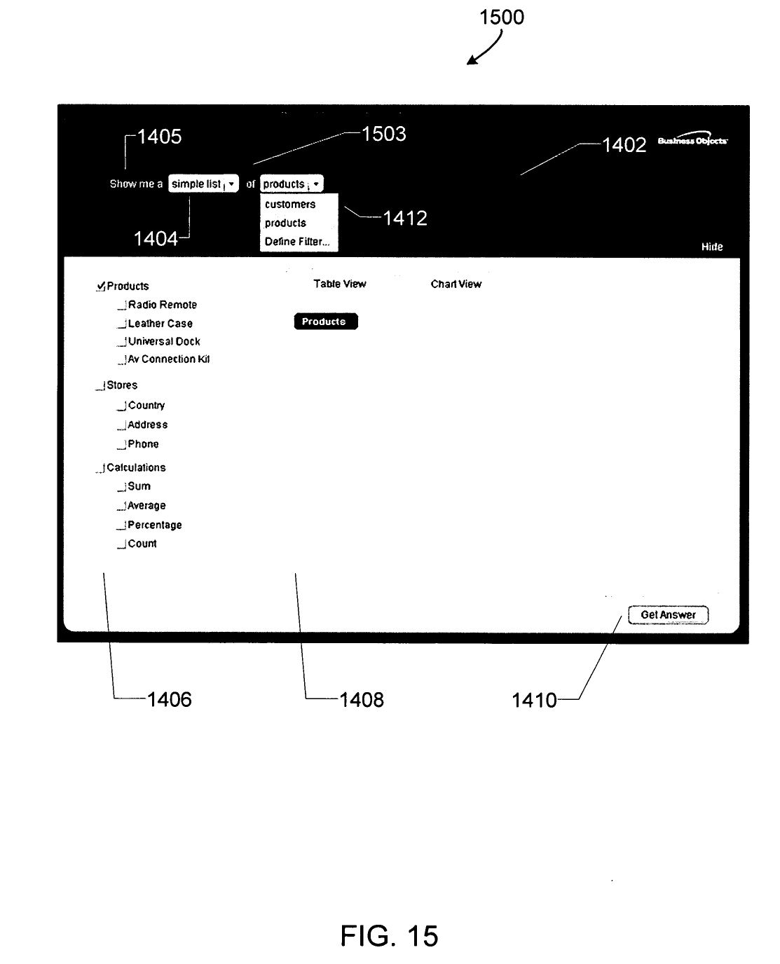

FIG. 15 illustrates a GUI 1500 which generally corresponds to FIG. 14, except in FIG. 15 a pull-down menu is activated to allow a user to select a second value for a first selectable sentence component 1412 of the text question 1503 displayed in question panel 1402, relative to a first value of the first selectable sentence component 1412 which is supplied to the user initially. In the GUI 1500, “products” is shown as the selected second value in the dropdown menu for the subject selectable sentence component 1412. When a second value is selected for a first selectable sentence component, such as by the use of a pull-down menu such as the one illustrated for selectable sentence component 1412, the question validity module 1216 and grammar module 1222 may be jointly implemented to determine if the resulting text question comprising the selected second value of the first selectable sentence component is invalid or grammatically incorrect, as described above in reference to FIG. 12. Also as described above, subsequent to the determination of validity and grammatical correctness by the question validity module 1216 and grammar module 1222, a second text question is displayed in the question panel 1402, comprising the selected second value of the first selectable sentence component, and other selectable and non-selectable sentence components including additions, deletions, modifications and/or re-ordering of the sentence components relative to the initial text question, if needed for validity and grammatical correctness, as determined by the question validity module 1216 or the grammar module 1222. This user selection of a second selectable sentence component value, determination of validity, and display of a second valid and grammatically correct text question correspond to the process operation of blocks 1302 and 1304 of the process of FIG. 13.

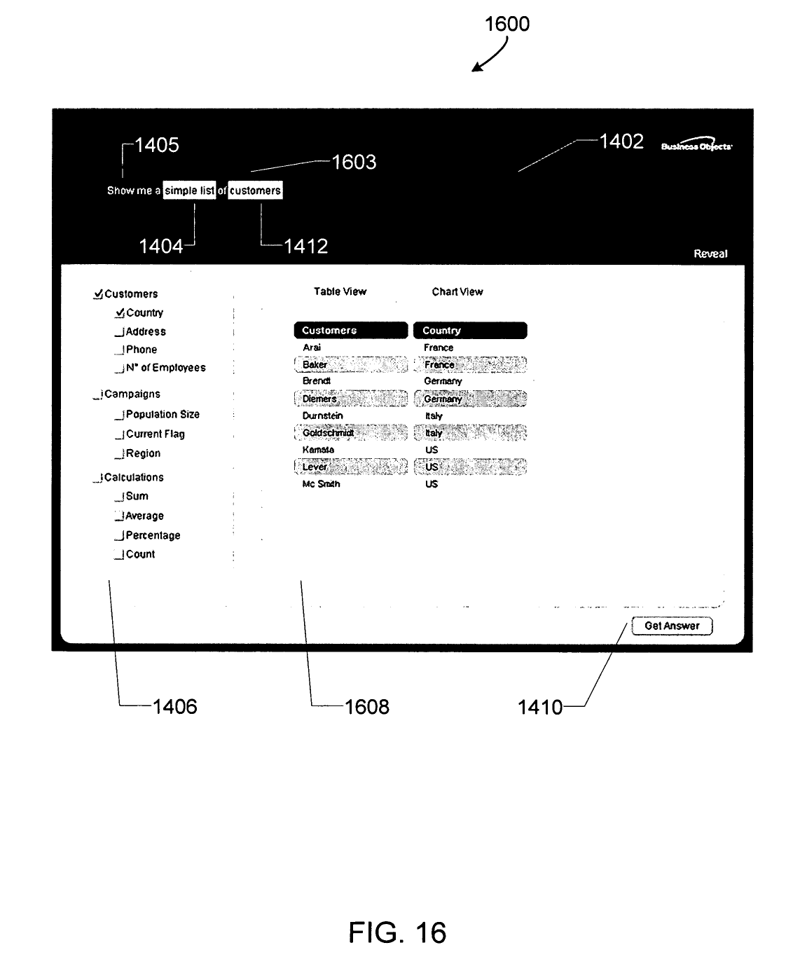

FIGS. 14 and 15 can be used to illustrate several of the remaining processing operations associated with FIG. 13. For example, FIG. 14 illustrates an initial text question as it may be supplied to a user (block 1300 of FIG. 13). FIG. 15 illustrates how a user may alter a selectable sentence component to select a second value (block 1302 of FIG. 13). Data query execution button 1410 may be selected by a user to construct a data source query from the text question displayed in question panel 1402 (block 1306 of FIG. 13), apply the data source query to a data source (block 1310 of FIG. 13), and subsequently display the data results of the data source query in the results panel 1408 (block 1312 of FIG. 13). The display of data results in the results panel 1408 is illustrated in FIG. 16 below.

FIG. 16 illustrates a GUI 1600 according to an embodiment of the present invention comprising the question panel 1402 displaying a text question 1603 as may be constructed by a user by selecting an altered value for selectable sentence component 1412. The results panel 1608 in FIG. 16 displays data results returned by the execution of a data source query based on the text question against a data source. The construction of the data source query from the text question, and the execution of the data source query against the data source to return the data results displayed in the results panel 1608 may be initiated by a user by selecting the data query execution button 1410 which is labeled “Get Answer”, following the construction of the desired text question in the question panel 1402. In the results panel 1608 of GUI 1600, the data results comprise a list of customers and countries corresponding to the data result categories selected in the formatting panel 1406.

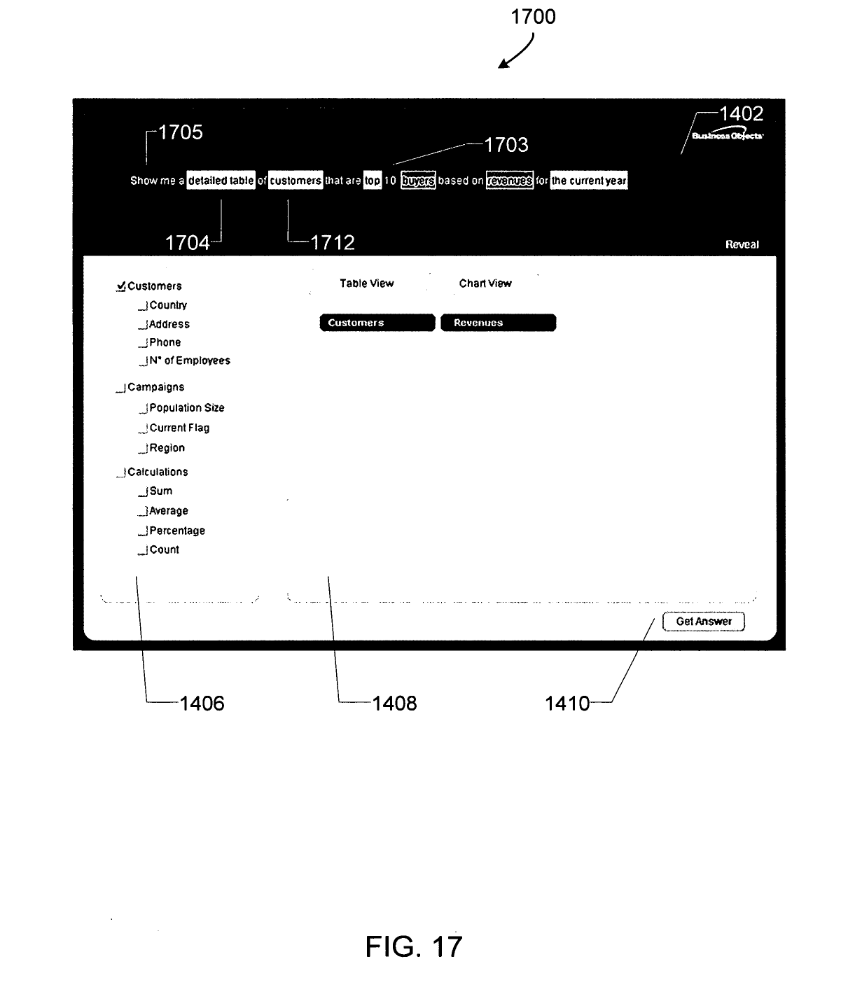

FIG. 17 illustrates another GUI 1700 implemented in accordance with an embodiment of the invention. GUI 1700 comprises question panel 1402 displaying a text question 1703 such as may be initially supplied to a user in the processing operations of FIG. 13, comprising selectable sentence components such as 1704 and 1712, and non-selectable sentence components, such as 1705. The text question displayed in question panel 1402 includes exemplary subject (“customers”), verb (“are”), predicate noun (“buyers”) and time period (“current year”) selectable sentence components, which are common types of sentence components in the text questions utilized in accordance with embodiments of the present invention. However, alternate and additional sentence components (selectable and non-selectable) may also be used in accordance with embodiments of the invention, such as in the remainder of the text question displayed in GUI 1700. Additionally, the data column headings displayed in the results panel 1408 comprise “Customers” and “Revenues” preview column headings to reflect the subject (customers) and data (revenues) columns to be displayed upon execution of a data query based on the displayed text question 1703 in question panel 1402.

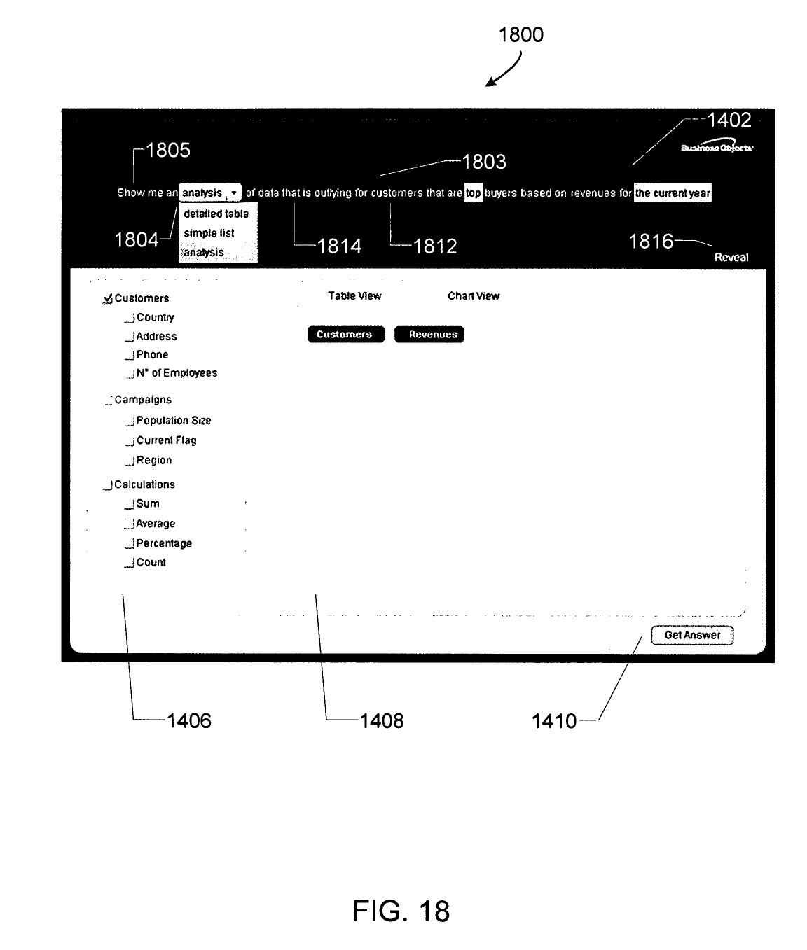

FIG. 18 illustrates a GUI 1800 which generally corresponds to FIG. 17, but shows an altered text question 1803 in question panel 1402 with a different selected value for a first selectable sentence component 1804 (which allows selection of the desired type of results to be returned by a data query based on the text question) relative to the text question 1703 displayed in question panel 1402 of FIG. 17. Following the user selection of “analysis” for the first selectable sentence component 1804, the question validity module 1216 and grammar module 1222 return a second altered text question 1803 as displayed in question panel 1402 of FIG. 18, comprising several changes (additions, deletions, modifications and/or changes of order) to other selectable and non-selectable sentence components, to ensure validity and grammatical correctness of the text question. In particular, the selection of “analysis” for the first selectable sentence component 1804 has resulted in the modification of the preface non-selectable sentence component 1805 to “Show me an” to reflect correct grammar in combination with “analysis” rather than the value “Show me a” for the preface non-selectable sentence component 1705 in the initial text question 1703 displayed in FIG. 17. Additionally, the selectable sentence component 1814 (with displayed value “data that is outlying for”) has been added to the text question 1803 in FIG. 18, thereby also representing a change in the order of sentence components, to ensure the validity of the question with an analysis results type selected for sentence component 1804. GUI 1800 also includes a selectable sentence component viewing toggle button 1816 which may be selected or activated by a viewer in order to display selectable dropdown boxes around each selectable sentence component in the displayed text question 1803. In this particular embodiment, the selectable sentence component viewing toggle button 1816 has not been selected by the user, and is labeled as “Reveal”, to indicate the function of the button to the user.

In an embodiment of the invention, the question validity module 1216 and grammar module 1222 supply a second valid and grammatically correct text question with changed an/or reordered sentence components in response to the alteration of a selectable sentence component, which facilitates the display of the text question in normally spaced continuous text form, as displayed in question panel 1402. This facilitates easy reading and selection of sentence components by a user. Additionally, as described above, in a further embodiment, the visible appearance of an altered sentence component may be modified (e.g., through highlighting, bolding, italics, different font, and the like). This allows the user to track and understand the impact of altering sentence components.

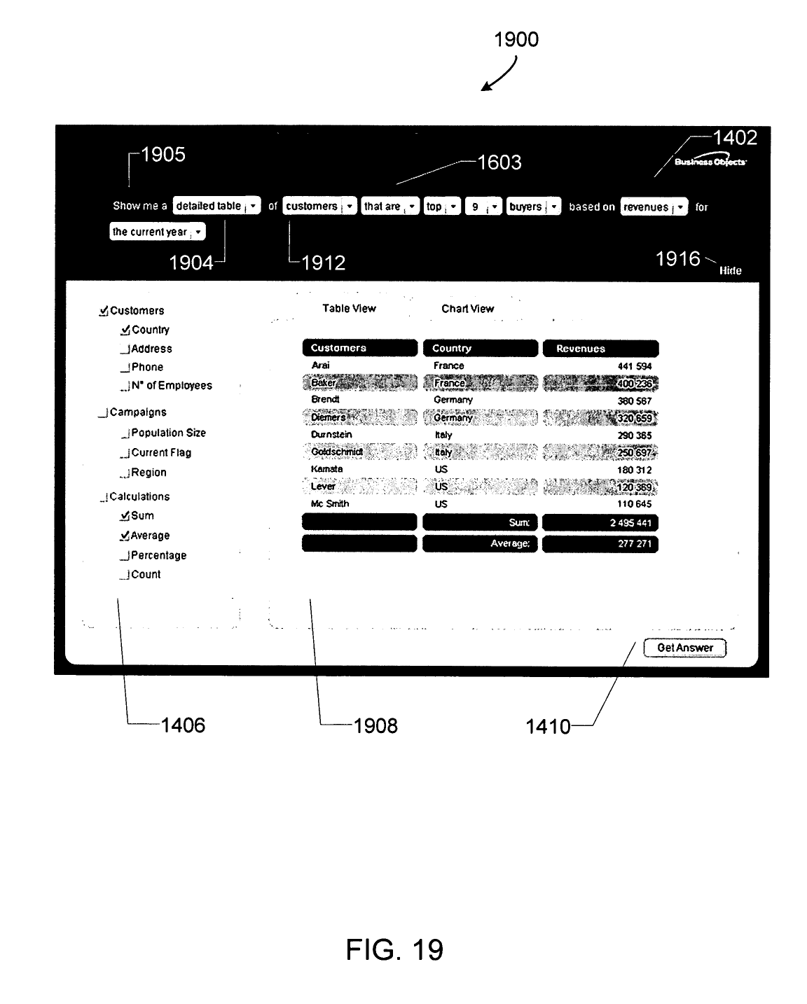

FIG. 19 illustrates a GUI 1900 according to an embodiment of the present invention comprising the question panel 1402 displaying a text question as may be constructed by a user. In this particular embodiment the selectable sentence component viewing toggle button 1916 has been activated by a user, resulting in the display of selectable dropdown boxes around each selectable sentence component in the displayed text question to make all selectable sentence components identifiable by a user. The results panel 1908 in FIG. 19 displays data results returned by the execution of a data source query based on the text question displayed in the question panel 1402 against a data source. The formatting panel 1406 of GUI 1900 displays particular data results formatting options selected by the user prior to selection of. the execution button 1410. The data results formatting options selected in formatting panel 1406 specify categories of data for inclusion in the results panel 1908, namely customers and corresponding country, and sum and average categories for revenue data. Accordingly, the data results displayed in results panel 1908 following execution of a data source query based on the text question displayed in question panel 1402 include customer, country and revenue columns, and sum and average revenue summary calculations.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer readable medium storing executable instructions to deterministically construct a text question for application to a data source, comprising executable instructions to:
supply a user with an initial text question;
allow the user to alter a sentence component of the initial text question to form an altered sentence component;
identify when the altered sentence component in combination with remaining sentence components creates a grammatically incorrect question;
supply a grammatically correct text question including the altered sentence component in response to the executable instructions to identify;
construct a data source query from the grammatically correct text question;
apply the data source query to a data source to produce data results; and
present the data results to the user.

2. The computer readable medium of claim 1 further comprising executable instructions to add a plurality of selectable sentence components in response to the altered sentence component, wherein each selectable sentence facilitates subsequent selection of a valid question.

3. The computer readable medium of claim 1 wherein the executable instructions to allow include executable instructions to supply a pull-down menu of sentence components that may be altered.

4. The computer readable medium of claim 1 further comprising executable instructions to offer the user a plurality of formatting options for the data results.

5. The computer readable medium of claim 1 further comprising executable instructions to modify the visible appearance of an altered sentence component.

6. A computer readable medium storing executable instructions to deterministically construct a text question for application to a data source, comprising executable instructions to:
supply a user with a first valid and grammatically correct text question comprising a set of first values of selectable and non-selectable sentence components, and supply a first list of possible values for a selectable sentence component;
allow the user to alter the selectable sentence component to select a second value of the selectable sentence component from the first list of possible values;
determine when the second value in combination with the remaining set of first values creates an invalid or grammatically incorrect question, and supply the user with a second valid and grammatically correct text question comprising the second value, a set of modified values of selectable and non-selectable sentence components, and a second list of possible values for the second value;
construct a data source query from the second valid and grammatically correct text question;
apply the data source query to a data source to produce data results; and
present the data results to the user.

7. The computer readable medium of claim 6 wherein the second list of possible values facilitates the selection of new valid and grammatically correct text question.

8. The computer readable medium of claim 6 wherein the second valid and grammatically correct text question includes selectable and non-selectable sentence components in a different order than the order of the selectable and non-selectable sentence components of the first valid and grammatically correct text question.

9. The computer readable medium of claim 6 wherein the executable instructions to allow include executable instructions to supply a pull-down menu displaying the first list of possible values.

10. The computer readable medium of claim 6 wherein the executable instructions to supply include executable instructions to supply a user with a first valid and grammatically correct text question comprising a selectable sentence component selected from a subject, a verb, a predicate noun and a time period.

11. The computer readable medium of claim 6 further comprising executable instructions to offer the user a plurality of formatting options for the data results.

12. The computer readable medium of claim 6 further comprising executable instructions to modify the visible appearance of an altered selectable sentence component.

13. A method of deterministically constructing a text question for application to a data source, comprising:
supplying a user with an initial text question;
allowing the user to alter a sentence component of the initial text question to form an altered sentence component;
identifying when the altered sentence component in combination with remaining sentence components creates a grammatically incorrect question;
supplying a grammatically correct text question including the altered sentence component in response to identifying;
constructing a data source query from the grammatically correct text question;
applying the data source query to a data source to produce data results; and
presenting the data results to the user.

14. The method of claim 13 further comprising adding a plurality of selectable sentence components in response to the altered sentence component, wherein each selectable sentence component facilitates subsequent selection of a valid question.

15. The method of claim 13 wherein allowing includes supplying a pull-down menu of sentence components that may be altered.

16. The method of claim 13 further comprising offering the user a plurality of formatting options for the data results.

17. The method of claim 13 further comprising modifying the visible appearance of an altered sentence component.
